(19) United States
(12) Patent Application Publication
(10) Pub. No.: US 2016/0139708 A1
(43) Pub. Date: May 19, 2016

(54) TOUCH PANEL

(71) Applicant: Industrial Technology Research Institute, Hsinchu (TW)

(72) Inventors: Kuo-Hua Tseng, New Taipei City (TW); Su-Tsai Lu, Hsinchu City (TW); Heng-Tien Lin, Hsinchu County (TW)

(21) Appl. No.: 14/934,170

(22) Filed: Nov. 6, 2015

Related U.S. Application Data
(60) Provisional application No. 62/078,981, filed on Nov. 13, 2014.

(51) Int. Cl. G06F 3/044; G06F 3/041; G06F 3/047

(52) U.S. Cl. CPC G06F 3/044; G06F 3/047; G06F 3/0416; G06F 2203/04106; G06F 2203/04111; G06F 2203/04112; G06F 2203/04103

(57) ABSTRACT

In one embodiment, a touch panel includes a substrate, a plurality of first and second sensing units, a plurality of wirings, a touch circuit unit, and at least one impedance adjustment means. The substrate has an active area and a peripheral area. The sensing units are disposed in the active area. The wirings are disposed in the peripheral area. The first sensing units and the plurality of wirings form first sensing channels, and the second sensing units and the plurality of wirings form second sensing channels. Impedances corresponding to the first or the second sensing channels are adjusted to substantially approximate a consistent impedance by using the impedance adjustment means.

### CROSS-REFERENCE TO RELATED APPLICATION

This application claims the priority benefits of U.S. provisional application Ser. No. 62/078,981, filed on Nov. 13, 2014. The entirety of the above-mentioned patent application is hereby incorporated by reference herein.

### TECHNICAL FIELD

The present disclosure relates to a touch panel having an impedance adjustment means or a touch circuit unit compensating impedance differences of a plurality of sensing channels.

### BACKGROUND

Based on different sensing types, a touch panel may be generally categorized as one of a capacitive touch panel, a resistive touch panel, an optical touch panel, an acoustic-wave touch panel, and an electromagnetic touch panel. Among these touch panels, the capacitive touch panel has advantages of such as short response speed, favorable reliability, high definition, and so on, therefore, it has been widely applied in various electronic products.

A capacitive touch panel usually includes a plurality of sensing units and a plurality of wirings. One end of each wiring is connected to one of the sensing units to form a sensing channel, and the other end of the wiring is bonded to a signal transmission circuit to electrically connect to a touch circuit unit via the signal transmission circuit. In the capacitive touch panel, an impedance difference may exist between the sensing channels due to issues such as component aging, variations in the manufacturing process, or different lengths of the sensing channels. The impedance difference of sensing channels may leads to a negative impact on a device performance of the capacitive touch panel, such as reduction in uniformity or response speed, and so on. As a dimension of the capacitive touch panel increases, the negative impact on the touch system performance is bound to become increasingly significant. Accordingly, how to reduce the impedance differences between different sensing channels is indeed a future trend.

### SUMMARY

The present disclosure is directed to a touch panel, making impedances corresponding to a plurality of first or second sensing channels to substantially approximate a consistent impedance.

In one embodiment of the present disclosure, a touch panel may comprise a first substrate, a plurality of first sensing units, a plurality of second sensing units, a plurality of wirings, and at least one impedance adjustment means. The first substrate has an active area and a peripheral area. The plurality of first sensing units are disposed along a first direction in the active area. The plurality of second sensing units are disposed along a second direction in the active area. The plurality of wirings have difference lengths and are disposed in the peripheral area. The plurality of first sensing units and the plurality of wirings form a plurality of first sensing channels, and the plurality of second sensing units and the plurality of wirings form a plurality of second sensing channels. The plurality of first sensing channels or the plurality of second sensing channels are connected to a signal transmission circuit. The at least one impedance adjustment means makes a plurality of impedances corresponding to the plurality of first sensing channels or the plurality of second sensing channels to substantially approximate a consistent impedance values.

In another embodiment of the disclosure, a touch panel may comprise a substrate, a plurality of first sensing units, a plurality of second sensing units, a plurality of wirings, an impedance adjustment means, and a touch circuit unit. The touch circuit unit further includes a processing unit, a RC adjusting unit and a power-supply unit. The substrate has an active area and a peripheral area. The plurality of first sensing units are disposed along a first direction in the active area. The plurality of second sensing units are disposed along a second direction in the active area. The plurality of wirings have difference lengths and are disposed in the peripheral area. The plurality of first sensing units and the plurality of wirings form a plurality of first sensing channels, and the plurality of second sensing units and the plurality of wirings form a plurality of second sensing channels. The plurality of first sensing channels or the plurality of second sensing channels are connected to a signal transmission circuit. The processing unit is coupled to a driving circuit and a memory unit. The RC adjusting unit is coupled to the driving circuit, wherein the RC adjusting unit performs an impedance compensation and makes a plurality of impedances corresponding to the plurality of first sensing channels or the plurality of second sensing channels to substantially approximate a consistent impedance.

### BRIEF DESCRIPTION OF THE DRAWINGS

FIG. 1A is a top view of a touch panel according to an embodiment of the present disclosure.

FIG. 1B and FIG. 1C are enlarged views of an area A and an area B in FIG. 1A, respectively, according to a first embodiment of the present disclosure.

FIG. 1D and FIG. 1E are first-type cross-sectional views taken along section lines A-A′ and B-B′ in FIG. 1A, respectively.

FIG. 2A and FIG. 2B are cross-sectional views taken along section lines A-A′ and B-B′ in FIG. 1A, respectively, according to a second embodiment of the present disclosure.

FIG. 3A and FIG. 3B are cross-sectional views taken along section lines A-A′ and B-B′ in FIG. 1A, respectively, according to a third embodiment of the present disclosure.

FIG. 4A and FIG. 4B are partial top views illustrating the densities and the line widths of the mesh patterns of a touch panel according to an embodiment of the present disclosure, respectively.

FIG. 5A is an enlarged view of one of the wirings according to an embodiment of the present disclosure.

FIG. 5B is a partial top view of a touch panel according to another embodiment of the present disclosure.

FIG. 5C is a cross-sectional view taken along a section line C-C′ in FIG. 5B.

FIG. 5D is a partial top view of a touch panel according to yet another embodiment of the present disclosure.

FIG. 6 is a partial top view illustrating how to change the impedance differences between the wirings of a touch panel according to still another embodiment of the present disclosure.

FIG. 7 is a block diagram of a touch circuit unit according to an embodiment of the disclosure.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

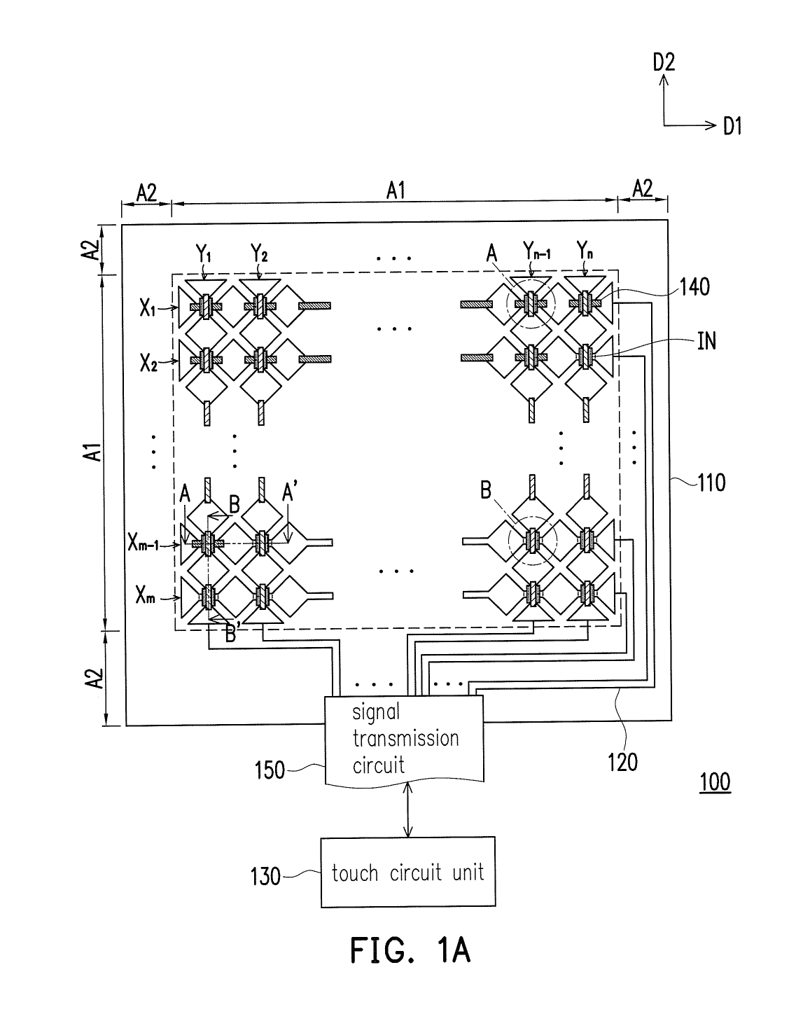

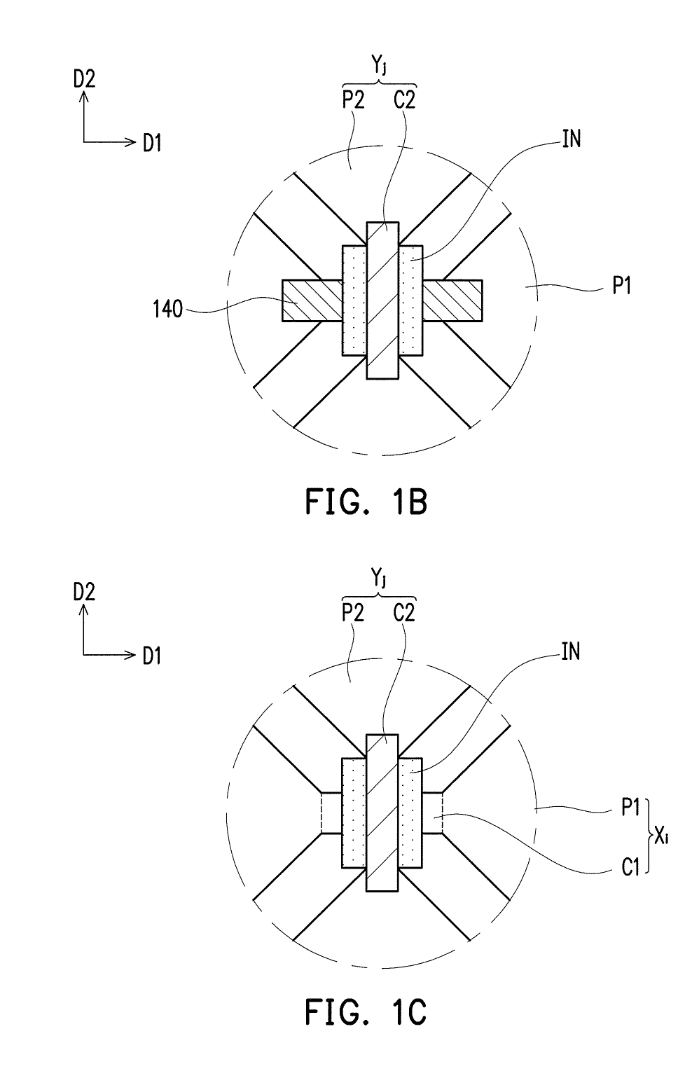

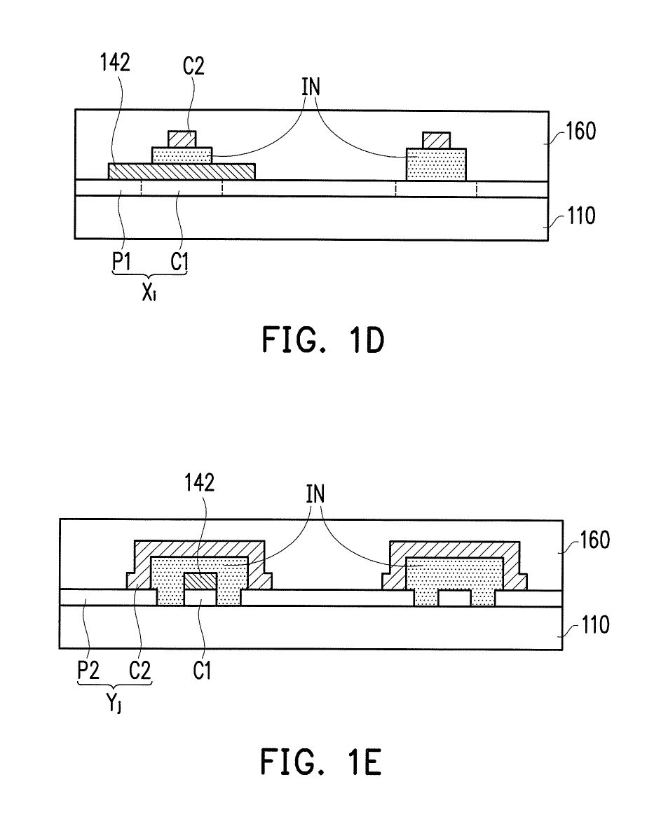

FIG. 1A is a top view of a touch panel according to an embodiment of the present disclosure. FIG. 1B and FIG. 1C are enlarged views of an area A and an area B in FIG. 1A, respectively. FIG. 1D and FIG. 1E are first-type cross-sectional views taken along section lines A-A′ and B-B′ in FIG. 1A, respectively. Referring to FIG. 1A to FIG. 1E, a touch panel 100 comprises a substrate (Sub1) 110, a plurality of first sensing units X₁ to Xₘ and second sensing units Y₁ to Yₙ, a plurality of wirings 120, a touch circuit unit 130 and at least one impedance adjustment means 140.

The substrate (Sub1) 110 may be a device substrate in a display panel, or a substrate disposed outside the display panel. The former is, for example, an opposite substrate of a liquid crystal display panel, a package cover lens of an organic light-emitting diode, and so on. The latter is, for example, a cover lens externally added outside the display panel, but the present disclosure is not limited thereto.

The substrate (Sub1) 110 has an active area A1 and a peripheral area A2. The peripheral area A2 is located on at least one side of the active area A1, and the peripheral area A2 surrounds the active area A1 for example, but the present disclosure is not limited thereto. The first sensing units X₁ to Xₘ are disposed along a first direction D1 and the second sensing units Y₁ to Yₙ are disposed along a second direction D2 in the active area A1. In the present embodiment, the first sensing units X₁ to Xₘ and the second sensing units Y₁ to Yₙ are intersected with each other, and both the first sensing units X₁ to Xₘ and the second sensing units Y₁ to Yₘ are disposed on a same side of the substrate (Sub1) 110. The touch panel 100 may further include a plurality of insulation patterns IN. The plurality of insulation patterns IN may maintain an independent electrical property for each of the first sensing units X₁ to Xₘ and the second sensing units Y₁ to Yₙ. For example, the plurality of insulation patterns IN may be disposed at intersections between the first sensing units X₁ to Xₘ and the second sensing units Y₁ to Yₙ, such that the first sensing units X₁ to Xₘ and the second sensing units Y₁ to Yₙ are structurally separated from each other.

As shown in FIG. 1A to FIG. 1C, each first sensing unit Xi includes a plurality of electrode pads P1 and a plurality of connecting portions C1, and each of the connecting portions C1 connects two adjacent electrode pads P1 in series along the first direction D1. Herein, i is a positive integer, and 1≦i≦m. On the other hand, each second sensing unit Yⱼ includes a plurality of electrode pads P2 and a plurality of connecting portions C2, and each of the connecting portions C2 connects two adjacent electrode pads P2 in series along the second direction D2. Herein, j is a positive integer, and 1≦j≦n. The second direction D2 is intersected with the first direction D1. For example, the second direction D2 and the first direction D1 may be perpendicular to each other, but the present disclosure is not limited thereto.

The electrode pads P1 and the electrode pads P2 are not overlapped with each other, and the connecting portions C1 and the connecting portions C2 are intersected with each other such that each of the connecting portions C1 is partially overlapped with one of the connecting portions C2. In the present embodiment, a manufacturing process of the first sensing units X₁ to Xₘ, the second sensing units Y₁ to Yₙ and the insulation patterns IN may include the following steps. At first, the first sensing units X₁ to Xₘ and the electrode pads P2 of the second sensing units Y₁ to Yₙ are formed on the first substrate (Sub1) 110, in which the first sensing units X₁ to Xₘ and the electrode pads P2 of the second sensing units Y₁ to Yₙ may be manufactured by using a same manufacturing process. Subsequently, the insulation patterns IN are formed, in which each of the insulation patterns IN covers one of the connecting portions C1 and a partial area of each of the electrode pads P2 that is close to the connecting portion C1. Then, the connecting portions C2 are formed, in which each of the connecting portions C2 crosses over one of the insulation patterns IN to connect two adjacent electrode pads P2 in series along the second direction D2.

The present disclosure is not intended to limit a manufacturing order of the first sensing units X₁ to Xₘ, the second sensing units Y₁ to Yₙ and the insulation patterns IN. In another embodiment, the connecting portions C2 may be manufactured before the insulation patterns IN are manufactured, and the first sensing units X₁ to Xₘ and the second electrode pads P2 of the second sensing units Y₁ to Yₙ may be manufactured after the insulation patterns IN are manufactured. Alternatively, the insulation patterns IN may be replaced by an entire surface of a continuous insulation film, and one of the first sensing units X₁ to Xₘ and the second sensing units Y₁ to Yₙ (such as an Xᵢ) may be manufactured before the continuous insulation film is manufactured, and the other one of the first sensing units X₁ to Xₘ and the second sensing units Y₁ to Yₙ (such as an Yⱼ) may be manufactured after the continuous insulation film is manufactured.

A material of the first sensing units X₁ to Xₘ and the second sensing units Y₁ to Yₙ may be, but not limited to a transparent conductive material such as a metal oxide, a carbon nanotube, a silver nanowire, a graphene, a silicone, or other suitable transparent conductive materials. The metal oxide may be, for example, indium tin oxides, indium zinc oxides, aluminum tin oxides, aluminum zinc oxides, germanium indium zinc oxides, or other metal oxides. Alternatively, the material of the first sensing units X₁ to Xₘ and the second sensing units Y₁ to Yₙ may also be a metal or a metal alloy. The metal may be, for example, chosen from at least one of Ag, Al, Cu, Cr, Ti, Mo, Nb, and Nd. When the material of first sensing units X₁ to Xₘ and the second sensing units Y₁ to Yₙ includes materials with a low light transmittance such as the metal or the metal alloy, the first sensing units X₁ to Xₘ and the second sensing units Y₁ to Yₙ may be formed into a mesh pattern to improve the light transmittance. In addition, when the connecting portions C2 and the electrode pads P2 are manufactured by using different manufacturing processes, a material of the connecting portions C2 may be different from that of the electrode pads P2. Further, a material of the insulation patterns IN may be a transparent inorganic material or a transparent organic material.

The plurality of wirings 120 are disposed in the peripheral area A2, and a material thereof may be a metal or a metal alloy, and the wirings 120 may be formed into a mesh pattern to improve the light transmittance. Alternatively, the material of the wirings 120 may also be aforementioned transparent conductive material. In addition, the wirings 120, the sensing units X₁ to Xₘ and Y₁ to Yₙ and the insulation patterns IN may be manufactured by using a photolithography process. Alternatively, the wirings 120, the sensing units X₁ to Xₘ and Y₁ to Yₙ and the insulation pattern IN may also be manufactured by using a printing process, for example, so as to achieve low contamination and reduction in manufacturing costs.

The first sensing units X₁ to Xₘ and the wirings 120 form a plurality of first sensing channels (not shown in the FIG. 1), and the second sensing units Y₁ to Yₙ and the wirings 120 form a plurality of second sensing channels (not shown in the FIG. 1). In addition, one end of each of the wirings 120 that is not connected to the sensing units X₁ to Xₘ and Y₁ to Yₙ collectively extends to one side of the peripheral area A2, so as to facilitate in bonding the wirings 120 to a signal transmission circuit 150. The plurality of first or second sensing channels may be connected to a signal transmission circuit 150. The signal transmission circuit 150 may serve as a bridge between the sensing channels and the touch circuit unit 130, so as to electrically connect the sensing channels to the touch circuit unit 130. For instance, the signal transmission circuit 150 may be, but not limited to, a flexible print circuit board (FPC), and the touch circuit unit 130 may be, but not limited to, an integrated circuit (IC).

The scheme of making the impedances corresponding to the first sensing channels or the second sensing channels to substantially approximate a consistent impedance is further described as follows. The meaning of “the impedances corresponding to the plurality of first or second sensing channels substantially approximate a consistent impedance” is not limited to the impedance differences between the impedances corresponding to the plurality of first or second sensing channels being equal to 0. It refers to that there exists a maximum impedance difference between the impedances corresponding to the plurality of first or second sensing channels, which ensures that the touch panel 100 may be operated normally. In other words, the impedances corresponding to the first or second sensing channels may be adjusted, so that the impedance difference between the impedances corresponding to the first or second sensing channel may approach the consistent impedance.

In view of the following formula (1), an impedance Z and a resistance R are positively correlative. In view of the following formula (2), the resistance R and a length l are positively correlative, while the resistance R and a sectional area A are negatively correlative. In other words, the impedance Z and the length l are positively correlative, and the impedance Z and the sectional area A of the wiring are negatively correlative.

$$\begin{matrix}Z = R + j ω L + \frac{1}{j ω C} & ( 1 ) \\ R = ρ \frac{l}{A} & ( 2 )\end{matrix}$$

wherein j is an imaginary unit, ω is an angular frequency, L is an inductance, C is a capacitance, and ρ is a resistance coefficient.

Referring back to FIG. 1A, it is assumed that, in the active area A1, patterns of either the first sensing units X₁ to Xₘ or the second sensing units Y₁ to Yₙ are all the same and sectional areas of the wirings connected to either the first sensing units X₁ to Xₘ or the second sensing units Y₁ to Yₙ are all the same. In this exemplar, the impedance differences between the first sensing channels corresponding to the first sensing units X₁ to Xₘ or the second sensing channels corresponding to the second sensing units Y₁ to Yₙ mainly depend on lengths of the connected wirings 120. Take the first sensing units X₁ to Xₘ as an example, a first sensing unit Xᵢ farther away from the signal transmission circuit 150 in FIG. 1A requires a wiring 120 with a longer length to be electrically connected to the signal transmission circuit 150, when compared to another first sensing unit Xj that is closer to the signal transmission circuit 150. Accordingly, before an impedance compensation is performed, an impedance of a first sensing channel formed by the first sensing unit Xi (e.g., the first sensing unit X₁) farther away from the signal transmission circuit 150 and its connected wiring 120 in FIG. 1A is greater than that of another first sensing channel formed by the another first sensing unit Xj (e.g., the first sensing unit Xₘ) closer to the signal transmission circuit 150 and its connected wiring 120. After an impedance compensation is performed, each of impedances corresponding to the first sensing channels formed by the first sensing unit X₁ to Xm and the plurality of wirings 120 in FIG. 1A substantially approximates a consistent impedance.

One exemplary method of compensating the impedance differences between the sensing channels is described as follows. Take the exemplar that an impedance difference compensation is made to the first sensing channels formed by the first sensing units X₁ to Xₘ and the wirings 120 for illustration. According to the exemplary embodiments, this method may also be used by the at least one impedance adjustment means 140 of the present disclosure to compensate the impedance differences between the second sensing channels formed by the second sensing units Y₁ to Yₙ and the wirings 120.

As shown in the following formula (3), under ideal driving conditions, an impedance of each first sensing channel Zi is equivalent to the sum of an impedance Z(Xi) of each first sensing unit Xᵢ and an impedance Z(Xi_120) of its connected wiring 120. In the first sensing unit Xᵢ, a sectional area of the connecting area C1 is smaller than that of the electrode pad P1. In view of formula (2), it can be seen that, the smaller the sectional area is, the greater the impedance is. Therefore, an impedance Z(Xi_C1) of the connecting portion C1 of the first sensing unit Xᵢ is a major contribution part of the impedance Z(Xi) of the first sensing unit Xᵢ. Thus, this formula (3) may be simplified to be the following formula (4). In addition, this formula (4) may be further simplified to be the following formula (5) by considering the resistance but without considering the capacitance or inductance effect. By combining the formula (2) and the following formulas (6) and (7), the impedance of a wiring may be simplified to be a sheet resistance Rs(Xi_120) further multiplied by the length Li of the wiring—and divided by the width Wi of the wiring. Therefore, formula (5) may be further simplified to be the following formula (8). In the present embodiment, by omitting the sheet resistance Rs(Xi_120), an effect shown in the following formula (9) may be achieved with disposing the at least one impedance adjustment means 140. In other words, the impedances of two different first sensing channels, for example, a first sensing channel formed by a first sensing unit Xi and its connected wiring and another first sensing channel formed by the first sensing unit Xm closest to the signal transmission circuit 150 and its connected wiring, may substantially approximate a consistent impedance.

Zi=Z(Xi)+Z(Xi_120) (3)

Zi=Z(Xi_C1)+Z(Xi_120) (4)

Zi=R(Xi_C1)+R(Xi_120) (5)

A=H*W (6)

Rs=ρ/H (7)

Zi=R(Xi_C1)+Rs(Xi_120)*Li/Wi (8)

R(Xi_C1)+Li/Wi=R(Xm_C1)+Lm/Wm (9)

In the present embodiment of the disclosure, a method of adjusting impedance may include performing an impedance compensation on a portion having a greater impedance in each sensing unit such as each first sensing unit Xi, wherein the portion may be, but not limited to, a connecting portion such as C1. Accordingly, in one embodiment, the at least one impedance adjustment means 140 may further include a plurality of electrodes 142, and the plurality of electrodes 142 may be disposed by deliberating about the connecting portions C1. For example, each electrode of the at least one impedance adjustment means 140 may be disposed on one of the connecting portions C1, so that the at least one impedance adjustment means 140 may electrically connect to the one connecting portion, and effectively reduce the impedance of each sensing unit Xᵢ by reducing the impedance of each connecting portion. As shown in FIG. 1E, the impedance adjustment means 140 may be, for example, formed after the connecting portion is formed but before the insulation pattern IN is formed. A material of the at least one impedance adjustment means 140 may be the aforementioned transparent conductive material, the metal or the metal alloy. When the material of the at least one impedance adjustment means 140 is the metal or the metal alloy with a low light transmittance, the aforementioned mesh pattern may be formed to improve the light transmittance (translucent degree).

An amount of the at least one impedance adjustment means 140 to be disposed corresponding to each first or second sensing unit may be determined according to the impedance difference of the first or second sensing unit before an impedance adjustment is performed. Take FIG. 1A as an example, the amount of the at least one impedance adjustment means 140 is, for example, gradually reduced toward an opposite direction of the second direction D2. In addition, a shape and a contacted area with the connecting portion C1 of the at least one impedance adjustment means 140 may be determined according to actual design requirements, and may be, but not limited to, the mesh patterns illustrated in FIG. 1A to FIG. 1E. In one embodiment, a contacted area between the at least one impedance adjustment means 140 and the connecting portion C1 may be an area of the connecting portion C1 as illustrated in FIG. 1D. Wherein, an orthographic projection area of the impedance adjustment means 140 on the substrate (Sub1) 110 may be equal to or greater than that of the connecting portion C1 on the substrate (Sub1) 110. In another embodiment, the contacted area between the at least one impedance adjustment means 140 and the connecting portion C1 may also be an area of the impedance adjustment means 140. Wherein, the orthographic projection area of the at least one impedance adjustment means 140 on the substrate (Sub1) 110 may be smaller than that of the connecting portion C1 on the substrate (Sub1) 110.

Generally, with demands for narrow borders, a line width of the wirings 120 disposed in the peripheral area A2 usually require a further reduction. However, reducing the line width of the wirings 120 will lead to increase the impedance of the wirings 120. This may cause an overall increment in the impedances of the sensing channels. According to embodiments of the present disclosure, the at least one impedance adjustment means 140 is not only used to reduce-the impedance differences between the different sensing channels to make the impedances of the different sensing channels to substantially approximate a consistent impedance values, but also used to reduce the impedances of the sensing units located in the active area A1. This may reduce an overall impedance of the sensing channels and ensure that the touch panel 100 may be operated normally, so that the touch panel 100 may achieve an approximately ideal device performance.

In one embodiment, the touch panel 100 may further include a protection layer 160, wherein the protection layer 160 covers the sensing units X1 to Xm and Y1 to Yₙ, the wirings 120, the insulation patterns IN and the at least one impedance adjustment means 140, so as to provide a suitable protection for the aforementioned components. A material of the protection layer 160 may be, but not limited to, an inorganic material having a higher environmental resistance (e.g., scratch resistant). In yet another embodiment, the touch panel 100 may also include a cover lens, wherein the cover lens covers the sensing units X₁ to Xₘ and Y₁ to Yₙ, the wirings 120, the insulation patterns IN and the at least one impedance adjustment means 140, to provide further protections.

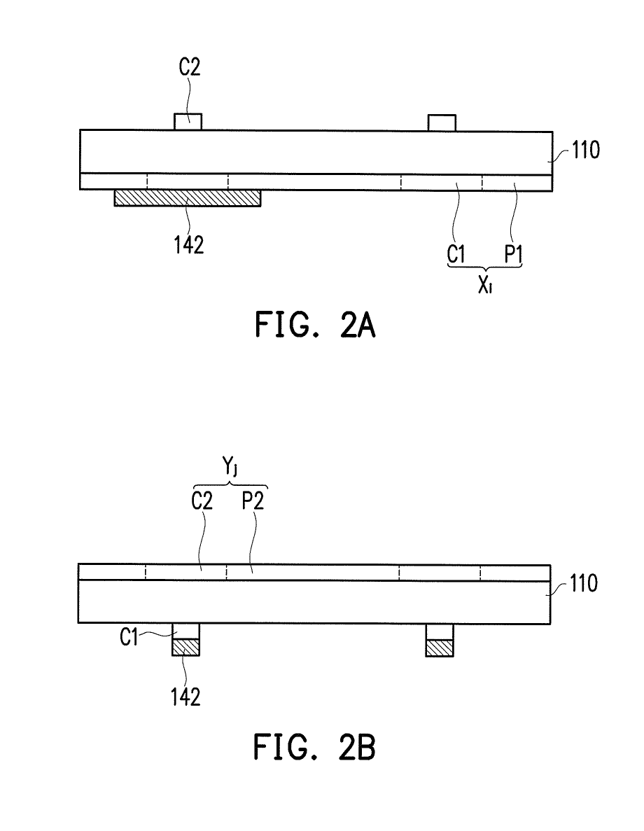

FIG. 2A and FIG. 2B are cross-sectional views of a second exemplary embodiment taken along section lines A-A′ and B-B′ in FIG. 1A, respectively. Referring to FIG. 2A and FIG. 2B, a touch panel of the present exemplary embodiment is substantially identical to the touch panels in FIG. 1D and FIG. 1E and the same elements are indicated by the same reference numbers, and thus related description thereof is omitted hereinafter. A major difference between the two is that, the sensing units Xᵢ and Yⱼ are respectively disposed on two opposite sides of the substrate (Sub1) 110, as shown in FIG. 2A and FIG. 2B. Therefore, the insulation patterns IN of FIG. 1D and FIG. 1E may be omitted in the touch panel of the present embodiment. The connecting portions C2 and the electrode pads P2 may be manufactured by using the same manufacturing process. Also, the at least one impedance adjustment means 140 and the sensing unit may be disposed on the same side of the substrate (Sub1) 110, in which the at least one impedance adjustment means 140 may be manufactured after the sensing unit is manufactured as shown in the drawings, or the at least one impedance adjustment means 140 may also be manufactured before the sensing unit is manufactured.

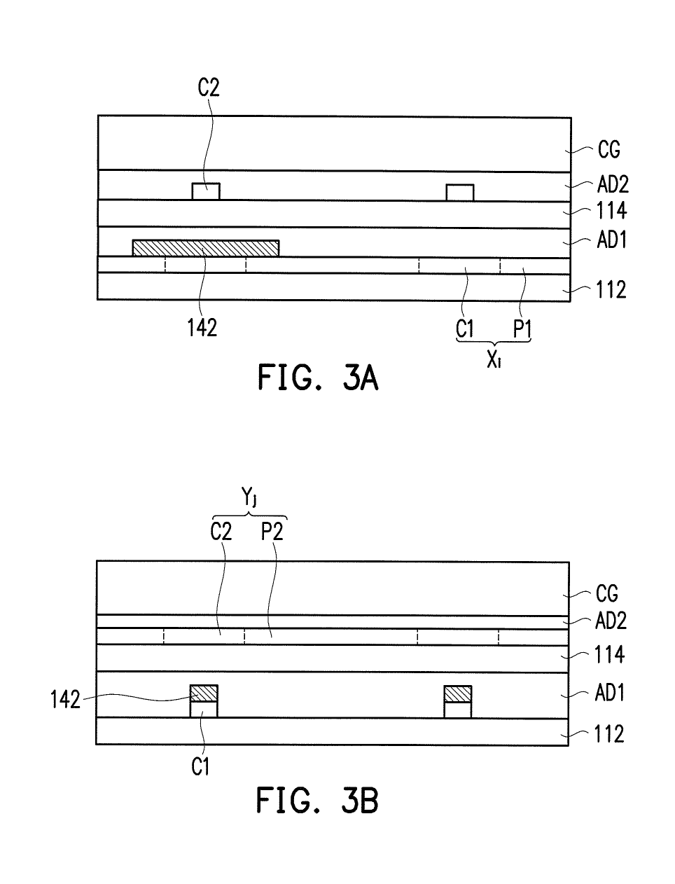

FIG. 3A and FIG. 3B are cross-sectional views of a third exemplary embodiment taken along section lines A-A′ and B-B′ in FIG. 1A, respectively. Referring to FIG. 3A and FIG. 3B, a touch panel of the present exemplary embodiment is substantially identical to the touch panels in FIG. 1D and FIG. 1E and the same elements are indicated by the same reference numbers, and thus related description thereof is omitted hereinafter. A major difference between the two is that, a touch panel of this embodiment includes a first substrate (Sub1) 112 and a second substrate (Sub2) 114 and a cover lens CG, as shown in FIG. 3A and FIG. 3B. The second substrate (Sub2) 114 is located between the substrate (Sub1) 112 and the cover lens CG, the first substrate (Sub1) 112 and the second substrate 114 are bonded to each other by an adhesion layer AD1, and the second substrate (Sub2) 114 and the cover lens CG are bonded to each other by an adhesion layer AD2. Each of the substrates 112 and 114 may be, but not limited to, a plastic substrate or a thin-glass substrate.

The sensing unit Xᵢ and the at least one impedance adjustment means 140 are disposed on the first substrate (Sub1) 112, and the sensing unit Xᵢ and the at least one impedance adjustment means 140 are located on one side of the adhesion layer AD1 further away from the second substrate (Sub2) 114. The sensing unit Yⱼ is disposed on the second substrate (Sub2) 114, and the sensing unit Yⱼ is located on one side of the adhesion layer AD2 further away from the cover lens CG, as shown in FIG. 3A and FIG. 3B. The insulation patterns IN of FIG. 1D and FIG. 1E may also be omitted in this embodiment. Further, the connecting portions C2 and the electrode pads P2 may be manufactured by using the same manufacturing process.

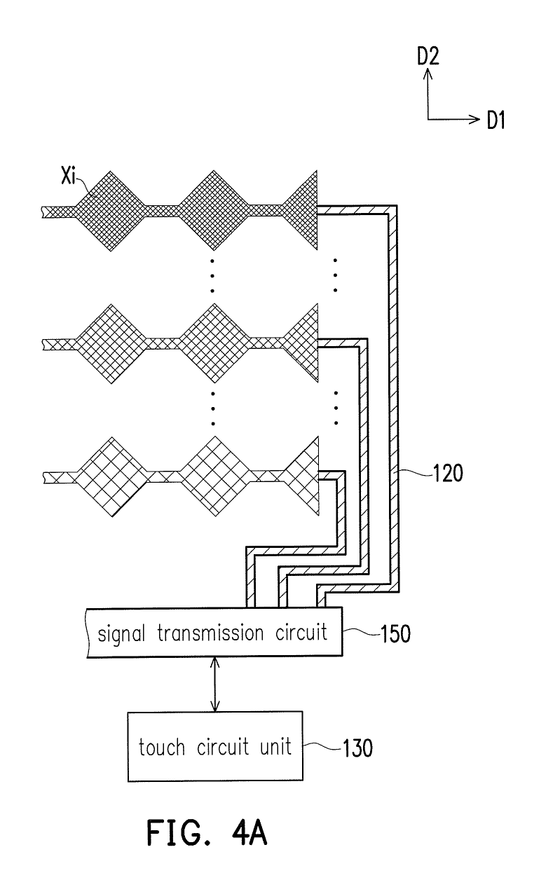

According to exemplary embodiments of the present disclosure, the aforementioned methods for adjusting the impedance of the sensing units Xᵢ in the active area A1 are not limited thereto. For example, when the sensing units Xᵢ are formed into a mesh pattern respectively, at least one of the density and the line width of the mesh pattern may be changed to make the impedances of different sensing channels to substantially approximate a consistent impedance. Specifically, the denser the density of the mesh pattern is, the lower the impedance of the corresponding sensing channel is. The larger the line width of the mesh pattern is, the lower the impedance of the corresponding sensing channel is. In one embodiment shown in FIG. 4A, densities of the mesh patterns of the first sensing units Xᵢ may be gradually reduced toward the opposite direction of the second direction D2 to reduce the impedance differences between the sensing channels. Alternatively, as shown in an embodiment of FIG. 4B, line widths of the mesh patterns of the first sensing units Xᵢ may be gradually reduced toward the opposite direction of the second direction D2 to reduce the impedance differences between the sensing channels. In another embodiment, the density and the line width of the mesh pattern may be adjustable at the same time to reduce the impedance differences between the sensing channels.

As aforementioned, the at least one impedance adjustment means 140 may adjust the impedances of the sensing units in the active area A1 to make the impedances of different sensing channels to substantially approximate a consistent impedance. While the impedances of the sensing units in the active area A1 may be adjusted, the present disclosure is not limited thereto. In another embodiment, the impedances of the wirings 120 in the peripheral area A2 may also be adjustable to make the impedances of the different sensing channels to substantially approximate a consistent impedance.

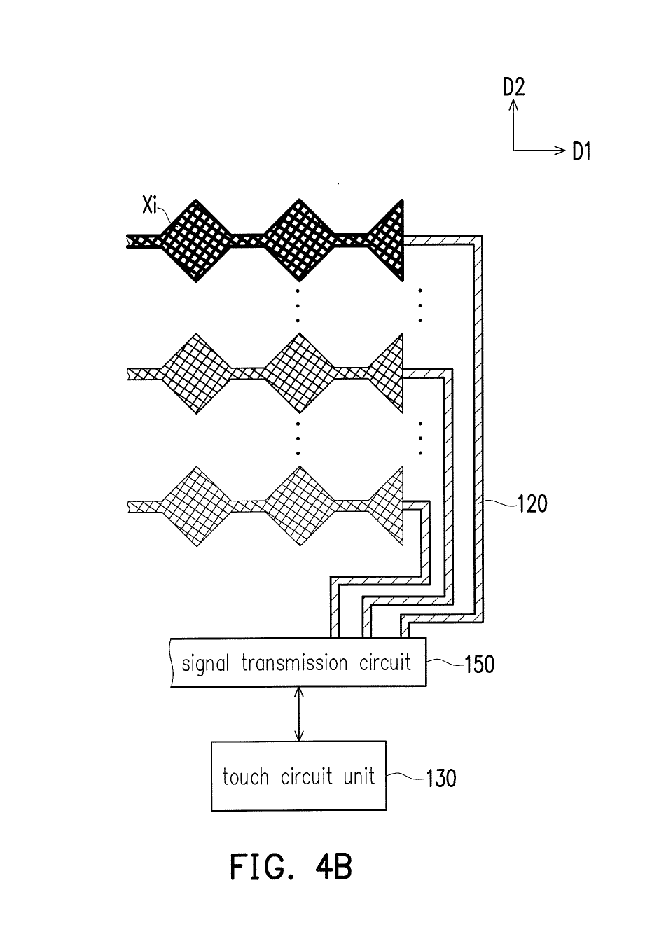

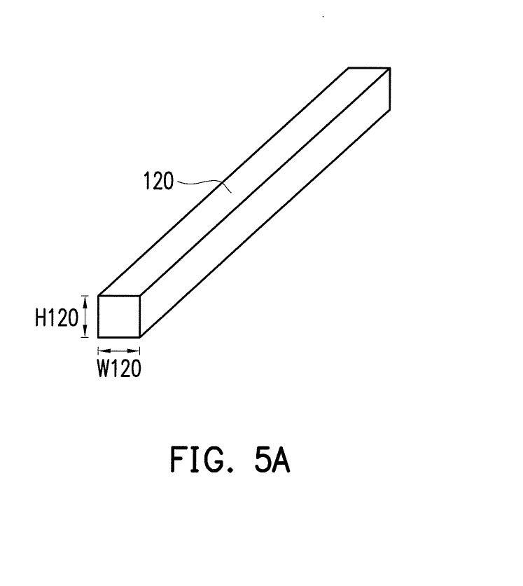

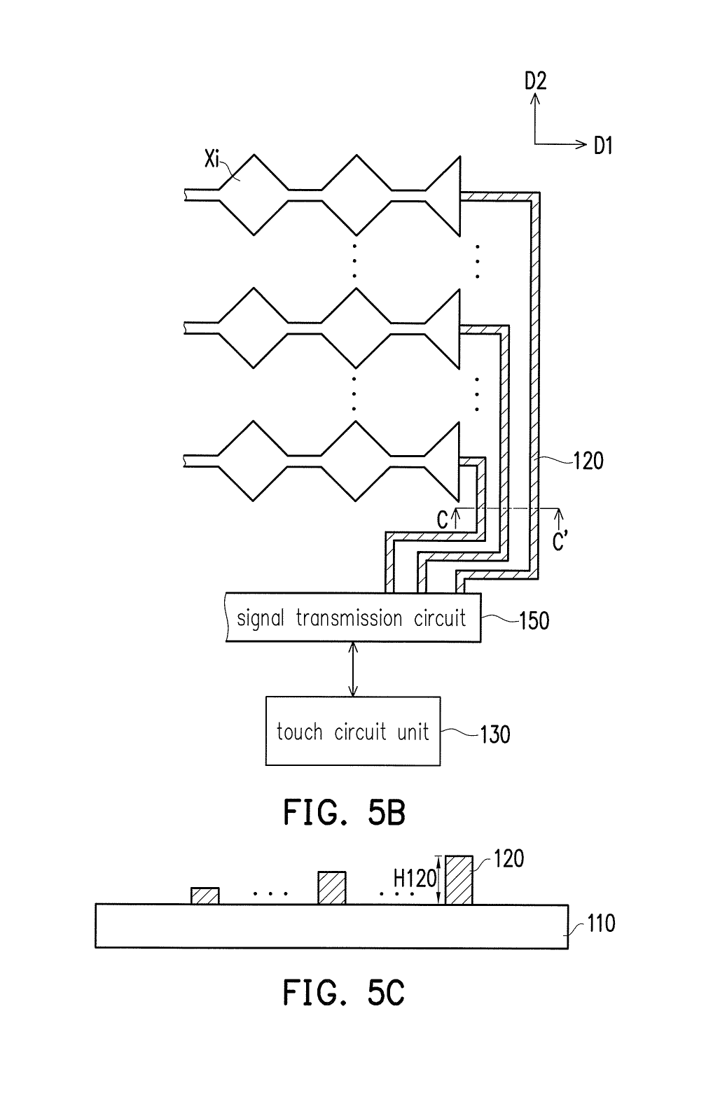

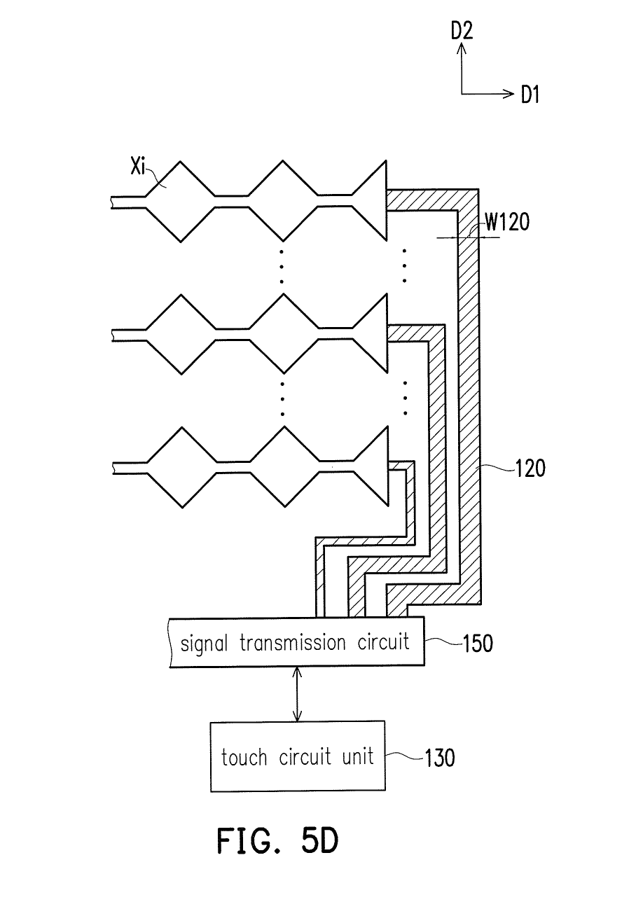

FIG. 5A is an enlarged view of one of the wirings according to an embodiment of the present disclosure. FIG. 5B is a partial top view of a touch panel according to another embodiment of the present disclosure. FIG. 5C is a cross-sectional view taken along a section line C-C′ in FIG. 5B. FIG. 5D is a partial top view of a touch panel according to yet another embodiment of the present disclosure. Referring to FIG. 5A, in view of formula (2), formula (7) and formula (8), it may be seen that the impedance of the wiring 120 and the sectional area of the wiring 120 are negatively correlative and the sectional area of the wiring 120 is equal to a width W120 of the wiring 120 multiplied by a thickness H120 of the wiring 120. In other words, the impedance of the wiring 120 negatively correlates with each of the width W120 and the thickness H120 of the wiring 120. In other words, when at least one of the width W120 and the thickness H120 of the wiring 120 is increased, the impedance of the wiring 120 is decreased. Accordingly, the embodiments of the present disclosure may change the at least one of the width W120 and the thickness H120 of the wiring 120 to reduce the impedance differences between the wirings 120, so that the impedance differences between the sensing channels are reduced.

As shown in FIG. 5B and FIG. 5C, when a length of the wiring 120 connected to the first sensing unit Xᵢ is longer, the thickness H120 of the wiring 120 may be greater. Further, as shown in FIG. 5D, when the length of the wiring 120 is longer, the width W120 of the wiring 120 may be greater. In another embodiment, the thickness H120 and the width W120 of the wiring 120 may also be changed at the same time to reduce the impedance differences between the first sensing channels. For the second sensing channel corresponding to the second sensing unit Yⱼ in FIG. 1A, the impedance differences between the second sensing channels may also be reduced by using aforementioned design, which is not repeated hereinafter.

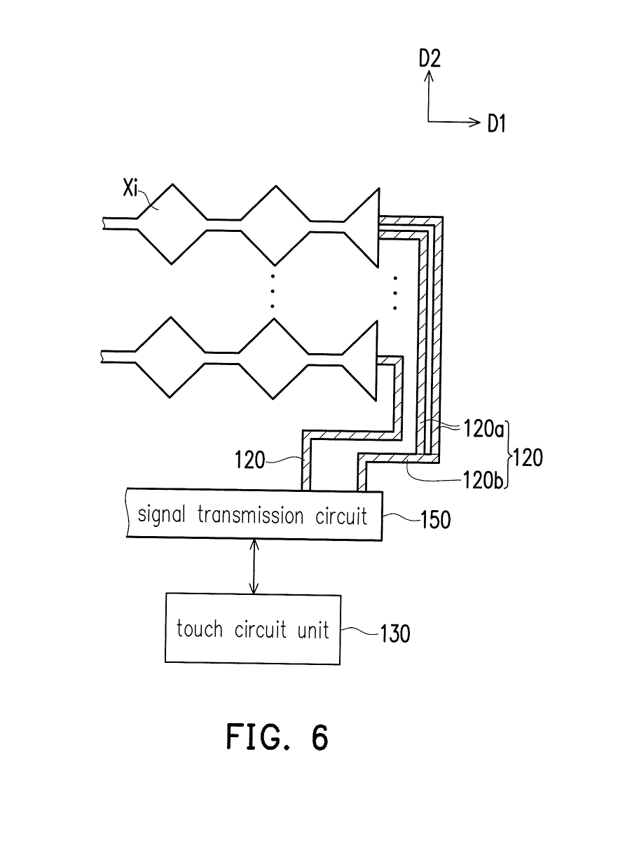

FIG. 6 is a partial top view illustrating how to change the impedance differences between the wirings of a touch panel according to still another embodiment of the present disclosure. The wirings 120 having a longer length in FIG. 1A may be changed to reduce their impedances, by changing each single wiring of the wirings 120 having a same longer length into a plurality of wirings connected in parallel. Take a rightmost wiring 120 as an example. An exemplary embodiment of changing the impedance differences between the wirings 120 in the peripheral area A2 may be shown in FIG. 6. Referring to the exemplary embodiment of FIG. 6, the rightmost wiring 120 includes at least two first portions 120a connected to each other in parallel and a second portion 120b connecting the at least two first portions 120a. The second portion 120b is, for example, connected to the end portions of the at least two first portions 120a and the second portion 120b is further bonded to the signal transmission circuit 150. The amount of the first portions 120a and the amount of the second portions 120b are not limited to what illustrated in FIG. 6. Also, a relative disposition relation of the first portion 120a and the second portion 120b is not limited to the exemplary embodiment illustrated in FIG. 6.

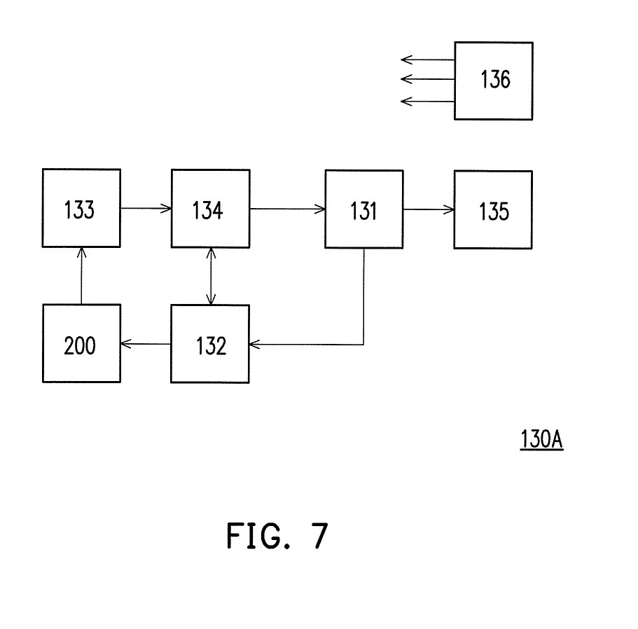

As aforementioned, the at least one impedance adjustment means may change the impedances of the first sensing units or the second sensing units in the active area A1, change the impedances of the wirings 120 in peripheral area A2, or change the impedances of the sensing units and the wiring 120 at the same time. According to the exemplary embodiments, the present disclosure may also compensate the impedance differences by changing the design of the touch circuit unit 130 in FIG. 1A. FIG. 7 is a block diagram of the touch circuit unit according to one embodiment of the disclosure. Referring to FIG. 7, a touch circuit unit 130A may comprise a processing unit 131, a driving circuit 132, a sensing unit 133, a RC adjusting unit 134, a memory unit 135 and a power-supply unit 136. The processing unit 131 is coupled to the driving circuit 132, the RC adjusting unit 134 and the memory unit 135. The driving circuit 132 is coupled to the RC adjusting unit 134 and a touch panel 200. The touch panel 200 is coupled to the sensing unit 133. The sensing unit 133 is coupled to the RC adjusting unit 134. The power-supply unit 136 supplies power, such as different electrical potentials, to at least one of the aforementioned components in the touch circuit unit 130A.

In the embodiment of FIG. 7, an impedance adjustment means performs the impedance compensation in a manner of system circuitry by disposing the RC adjusting unit 134. For example, driving signals and sensing signals of different sensing channels are compensated according to the sizes of the impedances of the sensing channels, so as to substantially achieve a consistent impedance. In another embodiment, the RC adjusting unit 134 may be, but not limited to, an electronic circuit configuration adjusting the impedance.

Although three different impedance adjustment means are disclosed in the foregoing embodiments, said three impedance adjustment means may be implemented independently or collectively. In other words, the present disclosure may achieve the effectiveness of consistent impedances for the sensing channels by using at least one of aforesaid impedance adjustment means. The touch panel of the present disclosure may achieve an approximately ideal device performance.

It will be apparent to those skilled in the art that various modifications and variations can be made to the disclosed embodiments. It is intended that the specification and examples be considered as exemplary only, with a scope of the disclosure being indicated by the following claims and their equivalents.

What is claimed is:

1. A touch panel, comprising:
a first substrate, having an active area and a peripheral area;
a plurality of first sensing units, disposed along a first direction in the active area;
a plurality of second sensing units, disposed along a second direction in the active area;
a plurality of wirings, having difference lengths and disposed in the peripheral area, wherein the plurality of first sensing units and the plurality of wirings form a plurality of first sensing channels and the plurality of second sensing units and the plurality of wirings form a plurality of second sensing channels, and the plurality of first sensing channels or the plurality of second sensing channels are connected to a signal transmission circuit; and
at least one impedance adjustment means, making a plurality of impedances corresponding to the plurality of first sensing channels or the plurality of second sensing channels to substantially approximate a consistent impedance.

2. The touch panel according to claim 1, wherein the plurality of first sensing units and the plurality of second sensing units are intersected with each other.

3. The touch panel according to claim 1, wherein each of both the plurality of first sensing units and the plurality of second sensing units has a plurality of electrode pads and a plurality of connecting portions, and the at least one impedance adjustment means is disposed on the plurality of connecting portions.

4. The touch panel according to claim 3, wherein the plurality of the electrode pads along the first direction and the plurality of the electrode pads along the second direction are not overlapped with each other.

5. The touch panel according to claim 1, wherein the plurality of first sensing units and the plurality of second sensing units are disposed on a same side or two opposite sides of the first substrate.

6. The touch panel according to claim 1, further comprising an insulation pattern disposed at an intersection between the plurality of first sensing units and the plurality of second sensing units.

7. The touch panel according to claim 1, wherein a material of the plurality of first sensing units and the plurality of second sensing units is selected from a group consisting of Ag, Al, Cu, Cr, Ti, Mo, Nb, Nd and alloys of metals.

8. The touch panel according to claim 1, wherein the plurality of the wirings, the plurality of the first sensing units and the plurality of the second sensing units are manufactured by a photolithography or a printing process.

9. The touch panel according to claim 1, wherein a material of the at least one impedance adjustment means is a metal and an alloy of the metal.

10. The touch panel according to claim 1, further comprising a protection layer disposed on the plurality of first sensing units and the plurality of second sensing units, wherein a material of the protection layer is an inorganic material.

11. The touch panel according to claim 1, further comprising a cover lens and a second substrate, wherein the second substrate is disposed between the first substrate and the cover lens.

12. The touch panel according to claim 11, wherein each of the first substrate and the second substrate is a plastic substrate or a thin-glass substrate.

13. The touch panel according to claim 1, wherein a line width or a thickness of each of the plurality of wirings gradually decreases toward the signal transmission circuit.

14. The touch panel according to claim 1, wherein each of the sensing units has a mesh pattern, and a density and a line width of the mesh pattern are adjustable.

15. The touch panel according to claim 14, wherein the density or the linewidth of the mesh pattern gradually decreases toward the signal transmission circuit.

16. A touch panel, comprising:
a first substrate, having an active area and a peripheral area;
a plurality of first sensing units, disposed along a first direction in the active area;
a plurality of second sensing units, disposed along a second direction in the active area;
a plurality of wirings, having difference lengths and disposed in the peripheral area, wherein the plurality of first sensing units and the plurality of wirings form a plurality of first sensing channels or the plurality of second sensing units and the plurality of wirings form a plurality of second sensing channels, and the plurality of first sensing channels or the plurality of second sensing channels are connected to a signal transmission circuit; and
a touch circuit unit, further comprising:
a processing unit, coupled to a driving circuit and a memory unit;
a RC adjusting unit, coupled to the driving circuit, wherein the RC adjusting unit performs an impedance compensation and makes a plurality of impedances corresponding to the plurality of first sensing channels or the plurality of second sensing channels to substantially approximate a consistent impedance; and
a power-supply unit.

17. The touch panel according to claim 16, wherein the plurality of first sensing units and the plurality of second sensing units are disposed on a same side or two opposite sides of the first substrate.

18. The touch panel according to claim 16, wherein at least one first impedance of the plurality of first sensing channels farther away from the signal transmission circuit is greater than at least one second impedance of the plurality of second sensing channels closer to the signal transmission circuit.

19. The touch panel according to claim 16, wherein a material of the impedance adjustment means is a metal and an alloy of the metal.

20. The touch panel according to claim 16, wherein a line width or a thickness of the plurality of wirings gradually decreases toward the signal transmission circuit.

21. The touch panel according to claim 16, wherein each of the sensing units has a mesh pattern, and a density or a line width of the mesh pattern gradually decreases toward the signal transmission circuit.
